(19) United States
(12) Patent Application Publication
(10) Pub. No.: US 2025/0289238 A1
(43) Pub. Date: Sep. 18, 2025

(54) TEST PATTERN, IMAGING CONTROL PROGRAM, AND PRINTING SYSTEM

(71) Applicant: SEIKO EPSON CORPORATION, Tokyo (JP)

(72) Inventor: Eishin YOSHIKAWA, Matsumoto (JP)

(21) Appl. No.: 19/078,341

(22) Filed: Mar. 13, 2025

(30) Foreign Application Priority Data
Mar. 15, 2024 (JP) 2024-040736

(51) Int. Cl. B41J 2/21; G06K 15/02; G06K 15/10

(52) U.S. Cl. CPC B41J 2/2135; G06K 15/027; G06K 15/102

(57) ABSTRACT

A test pattern used for imaging in the information terminal's imaging section to adjust printing characteristics of a printing device that includes a recording head, wherein a density pattern for adjusting printing density, as one of the printing characteristics, is included in an imaging target region of the test pattern and the arrangement region of the density pattern within the imaging target region is symmetrical with respect to either the center of the imaging target region or a straight line passing through the center as the reference.

The present application is based on, and claims priority from JP Application Serial Number 2024-040736, filed Mar. 15, 2024, the disclosure of which is hereby incorporated by reference herein in its entirety.

### BACKGROUND

### 1. Technical Field

The present disclosure relates to a test pattern for printing characteristics adjustment, an imaging control program for imaging the test pattern, and a printing system.

### 2. Related Art

A test pattern for adjusting printing characteristics of a printing device, such as an inkjet printer, is read by a scanner in the related art.

In JP-A-2005-136603, an image printing system is disclosed in which a test pattern for color matching printed by a printer is photographed by a digital camera to create a print correction table. This document describes that when a digital camera is provided with an automatic zoom function, an image is captured after automatically zooming to a position at which the amount of light at the periphery of the lens is not affected.

In the captured image, an effect of peripheral dimming may occur due to the structure of the lens. In particular, when a thin information terminal such as a smartphone is used for imaging, since the accommodation space of the imaging section is limited, peripheral dimming is likely to occur. When zoom is performed to a level at which peripheral dimming does not become a problem, the entire test pattern cannot be captured at once, and the test pattern needs to be captured many times. Therefore, it takes time to adjust the printing density, and a large amount of memory is required to store the captured image.

### SUMMARY

A test pattern according to an aspect of the disclosure, the test pattern that is used for imaging in the information terminal's imaging section to adjust printing characteristics of a printing device that includes a recording head, wherein
a density pattern for adjusting printing density, as one of the printing characteristics, is included in an imaging target region of the test pattern and
the arrangement region of the density pattern within the imaging target region is symmetrical with respect to either the center of the imaging target region or a straight line passing through the center as the reference.

An imaging control program according to the present disclosure is the imaging control program causes an imaging section to capture a test pattern for adjusting printing characteristics of a printing device including a recording head, wherein
a density pattern for adjusting printing density as a printing characteristic is included in an imaging target region of the test pattern,
an arrangement region of the density pattern within the imaging target region is symmetrical with respect to either a center of the imaging target region or a straight line passing through the center as a reference, and
the imaging control program enables a computer to execute:
   a determination function to judge whether an imaging condition is satisfied, the imaging condition including at least a condition of the center of the imaging target region being within a predetermined central region in an angle of view of the imaging section and
   an imaging control function configured to acquire a captured image by causing the imaging section to execute imaging of the imaging target region with satisfaction of the imaging condition as a trigger.

Further, a printing system of the present disclosure includes a printing device including a recording head and an information terminal configured to capture an image of a test pattern for adjusting printing characteristics of the printing device, wherein
a density pattern for adjusting printing density as a printing characteristic is included in an imaging target region of the test pattern,
an arrangement region of the density pattern within the imaging target region is symmetrical with respect to either a center of the imaging target region or a straight line passing through the center as a reference, and
the information terminal has
an imaging section and
a control section that includes a memory for storing a captured image obtained from the imaging section and that causes the imaging section to image the imaging target region, and
the control section judges whether an imaging condition is satisfied, including at least the condition that the center of the imaging target region is within a predetermined central region in the angle of view of the imaging section, and acquires the captured image by causing the imaging section to execute imaging of the imaging target region with satisfaction of the imaging condition as a trigger.

### BRIEF DESCRIPTION OF THE DRAWINGS

FIG. 1 is a diagram schematically illustrating an example of a printing system.

FIG. 2 is a diagram schematically illustrating a configuration example of a printing system.

FIG. 3 is a diagram schematically showing an example of a test pattern.

FIG. 4A is a diagram schematically showing another example of a test pattern.

FIG. 4B is a diagram schematically showing another example of a test pattern.

FIG. 4C is a diagram schematically showing another example of a test pattern.

FIG. 5 is a diagram schematically illustrating an example of a recording head and a density pattern in a serial type printing device.

FIG. 6 is a diagram schematically illustrating an operation example of the information terminal at the time of imaging.

FIG. 7 is a diagram schematically illustrating an example of a captured image of a test pattern and density values obtained from a density pattern.

FIG. 8 is a flowchart schematically showing an example of an imaging control process.

FIG. 9 is a diagram schematically illustrating an example of whether or not a condition that the center of the imaging target region is within the central region of the angle of view is satisfied.

FIG. 10 is a flowchart schematically illustrating an example of an adjustment process.

FIG. 11 is a graph schematically illustrating an example of acquiring an adjustment value G3i.

### DESCRIPTION OF EMBODIMENTS

Hereinafter, embodiments of the present disclosure will be described. Of course, the following embodiments merely exemplify the present disclosure, and not all features shown in the embodiments are necessarily essential to the solutions in the present disclosure.

### (1) Outline of Aspects Included in the Present Disclosure

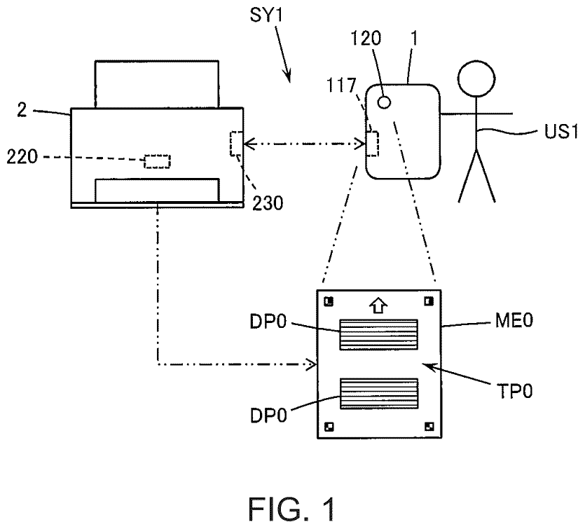

First, an outline of the aspects included in the present disclosure will be described with reference to the examples shown in FIGS. 1 to 11. Note that the drawings of the present application are diagrams that schematically show examples. The magnification ratios in the directions illustrated in these drawings may differ, and the respective drawings may not match. Of course, each element of the present aspect is not limited to a specific example indicated by a reference numeral. In the “Outline of aspects included in the present disclosure”, the term in parentheses means a supplementary explanation of the immediately preceding term.

### First Aspect

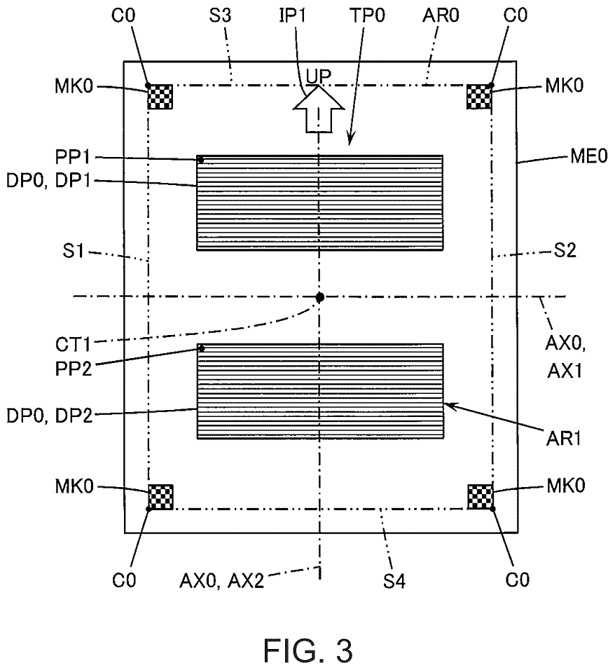

As exemplified in FIGS. 1 and 3, a test pattern TP0 according to an aspect is used for imaging by an imaging section 120 of an information terminal 1 to adjust the printing characteristics of a printing device 2, which includes a recording head 220, and includes a density pattern DP0 for adjusting printing density as the printing characteristics in the imaging target region AR0 of the test pattern TP0. An arrangement region AR1 of the density pattern DP0 with respect to the imaging target region AR0 is symmetrical with respect to either a center CT1 of the imaging target region AR0 or a straight line (for example, a symmetry axis AX0) passing through the center CT1, of the imaging target region AR0 as the reference.

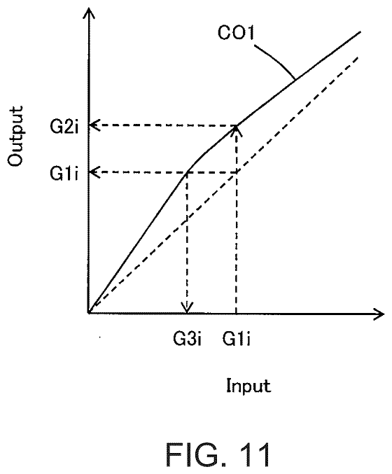

As described above, even when peripheral dimming occurs in a captured image IM0, it is possible to reduce the influence of peripheral dimming on the adjustment value (for example, an adjustment value G3i illustrated in FIG. 11) of the printing density based on the captured image IM0 of the symmetrically arranged density pattern DP0. Therefore, the above-described aspect can provide the test pattern capable of reducing an error in the adjustment value of the printing density due to peripheral dimming occurring in the captured image.

The aspects described above include various examples.

Examples of the imaging target region include the entire medium, a region partitioned by a plurality of finder patterns, and the like.

The arrangement region of the density pattern with respect to the imaging target region may be line-symmetric with respect to a straight line passing through the center of the imaging target region as the reference or may be point-symmetric with respect to the center of the imaging target region as the reference.

Test pattern means a medium having at least a density pattern.

Of course, the above-mentioned additional remarks also apply to the following aspects.

### Second Aspect

As exemplified in FIG. 3 and the like, the imaging target region AR0 may be rectangular. The test pattern TP0 may have a finder pattern MK0 at each of the four corner sections of the imaging target region AR0. The straight line (AX0) may be the symmetry axis AX0 oriented along a side of the rectangle (for example, vertical sides S1, S2 or horizontal sides S3, S4). The arrangement region AR1 of the density pattern DP0 within the imaging target region AR0 may be line-symmetric with respect to the symmetry axis AX0 as the reference.

In the above-described case, it is possible to provide the test pattern suitable for reducing an error in the adjustment value of the printing density due to peripheral dimming occurring in the captured image.

Although not included in the second aspect, a case where the test pattern TP0 has no finder pattern MK0 and the entire medium having at least the density pattern DP0 is the imaging target region AR0 is also included in the disclosure of the present application.

### Third Aspect

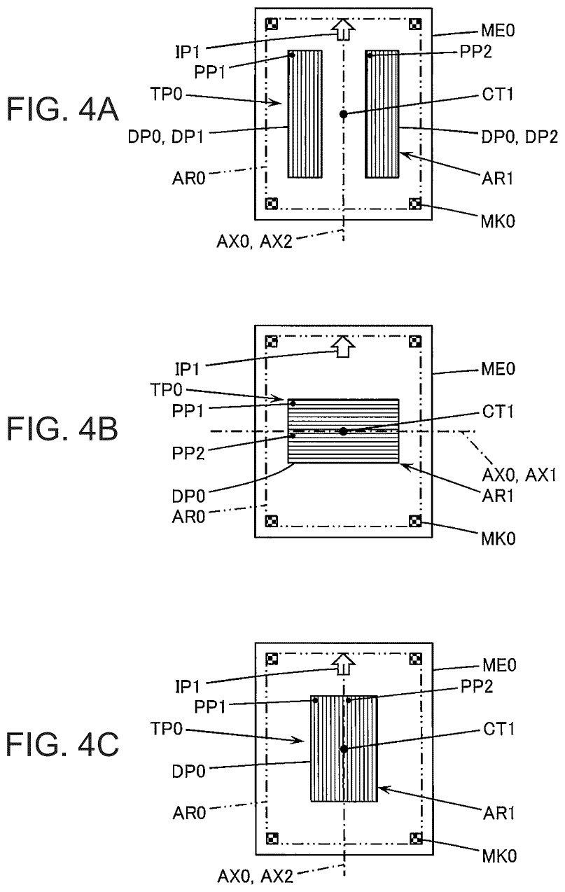

As exemplified in FIGS. 3 and 4A, there may be the plurality of density patterns DP0. The plurality of density patterns DP0 may include a first pattern DP1 and a second pattern DP2, both having the same shape. The arrangement region of the first pattern DP1 and the arrangement region of the second pattern DP2 may be symmetrical with respect to either the center CT1 or the straight line (AX0) as the reference.

In this case as well, it is possible to provide the test pattern suitable for reducing the error in the adjustment value of the printing density due to peripheral dimming occurring in the captured image.

Here, “first”, “second”, and the like in the present application are terms for identifying components included in a plurality of components that have similarities, and do not mean the order. The above-mentioned additional remarks also apply to the following aspects.

### Fourth Aspect

As exemplified in FIGS. 4B and 4C, in the imaging target region AR0, the density pattern DP0 may be located at a position including the center CT1, and the arrangement region AR1 of the density pattern DP0 may be symmetric with respect to either the center CT1 or the straight line (AX0) as the reference.

In this case as well, it is possible to provide the test pattern suitable for reducing the error in the adjustment value of the printing density due to peripheral dimming occurring in the captured image.

### Fifth Aspect

As exemplified in FIG. 3 and the like, the imaging target region AR0 may be a rectangle having long sides (for example, the vertical sides S1 and S2) and short sides (for example, the horizontal sides S3 and S4). The straight line (AX0) may be a symmetry axis AX1 along the short sides (S3, S4). The arrangement region AR1 of the density pattern DP0 within the imaging target region AR0 may be line-symmetric with respect to the symmetry axis AX1 as the reference.

In the above case, since the density pattern DP0 is not divided by the symmetry axis AX0, which is along the short sides (S3, S4), the density pattern DP0 can be made longer in the direction along the short sides (S3, S4). Therefore, the above-described aspect can also provide a suitable test pattern for reducing the error in the adjustment value of the printing density due to peripheral dimming occurring in the captured image.

### Sixth Aspect

As exemplified in FIG. 3 and similar figures, the test pattern TP0 may include an imaging direction indicating pattern IP1 that shows a direction of the imaging ensuring that the imaging section 120 captures an image with the long sides (S1, S2) oriented vertically.

In the above case, the user can grasp the orientation of the test pattern TP0 at the time of imaging by viewing the imaging direction indicating pattern IP1. Therefore, the above-described aspect can provide the test pattern suitable for reducing the error in the adjustment value of the printing density due to peripheral dimming occurring in the captured image.

### Seventh Aspect

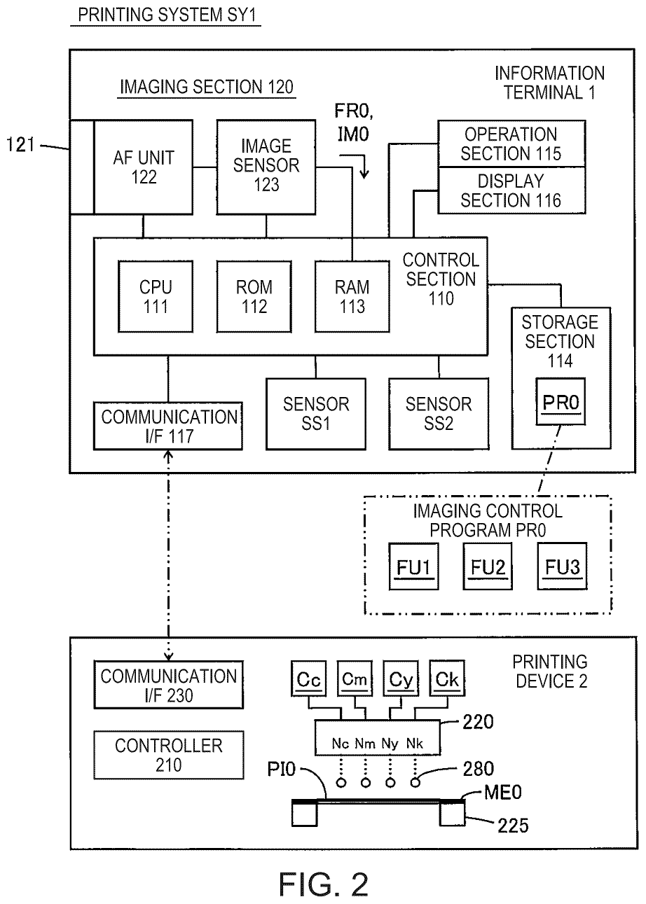

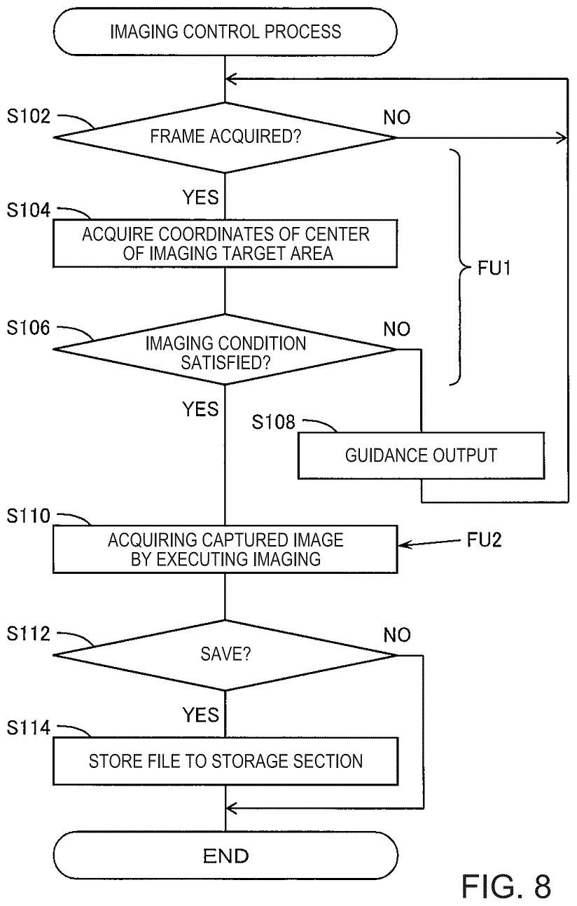

As exemplified in FIGS. 2 and 8, an imaging control program PR0 according to an aspect is the imaging control program PR0 for causing an imaging section 120 to capture the test pattern TP0 for adjusting the printing characteristics of a printing device 2 including a recording head 220, and causes a computer (for example, an information terminal 1) to realize determination function FU1 and imaging control function FU2. The determination function FU1 judges whether or not an imaging condition including at least a condition (also referred to as an alignment condition) that the predetermined center CT1 of the imaging target region AR0 is within the central region CA1 in an angle of view FA of the imaging section 120 is satisfied. The imaging control function FU2 acquires the captured image IM0 by causing the imaging section 120 to capture an image of the imaging target region AR0 with satisfaction of the imaging condition as a trigger.

The arrangement region AR1 of the density pattern DP0 with respect to the imaging target region AR0 of the test pattern TP0 is symmetrical with respect to either the center CT1 of the imaging target region AR0 or a straight line (AX0) passing through the center CT1, of the imaging target region AR0 as the reference. Since the imaging target region AR0 is captured with the satisfaction of the condition that the center CT1 of the imaging target region AR0 of the test pattern TP0 is included in the central region CA1 of the angle of view FA of the imaging section 120 as a trigger, even when peripheral dimming occurs in the captured image IM0, it is possible to reduce the influence of peripheral dimming on the ‘adjustment value of the printing density’ (G3i) based on the captured image IMO of the symmetrically arranged density pattern DP0. Therefore, the above-described aspect can provide the test pattern imaging control program capable of reducing the error in the adjustment value of the printing density due to peripheral dimming occurring in the captured image.

The aspects described above include various examples.

The acquisition of the captured image may involve storing the captured image obtained from the imaging section in the memory or may involve controlling the DMA (Direct Memory Access) controller to store the captured image in the memory. The storage in the memory includes storage in a RAM (Random Access Memory), storage in a non-volatile memory, and the like.

The angle of view refers to the imaging range.

Of course, the above-mentioned additional remarks also apply to the following aspects.

### Eighth Aspect

As exemplified in FIGS. 1 and 2, a printing system SY1 according to an aspect is the printing system SY1 including a printing device 2 that has a recording head 220 and an information terminal 1 that captures an image of the test pattern TP0 for adjusting the printing characteristics of the printing device 2. The information terminal 1 includes an imaging section 120, and a control section 110 which has a memory (for example, a RAM 113) for storing a captured image IM0 obtained from the imaging section 120 and causes the imaging section 120 to execute imaging of the imaging target region AR0. The control section 110 judges whether or not an imaging condition including at least a condition that the center CT1 of the imaging target region AR0 is within the predetermined central region CA1 in the angle of view FA of the imaging section 120 is satisfied, and acquires the captured image IM0 by causing the imaging section 120 to execute imaging of the imaging target region AR0 with satisfaction of the imaging condition as a trigger.

According to the eighth aspect, it is possible to provide a printing system capable of reducing an error in the adjustment value of the printing density due to peripheral dimming occurring in the captured image.

### Ninth Aspect

As illustrated in FIG. 3 and the like, the density pattern DP0 may include a first pattern section PPI and a second pattern section PP2, whose arrangement regions are symmetric with respect to either the center CT1 or the straight line (AX0) as the reference. The printing system SY1 may determine the ‘adjustment value of the printing density’ (G3i) as exemplified in FIG. 11 based on an average (for example, average value Ai) of a first value (for example, density value Aei) obtained from the first pattern section PP1 included in the captured image IM0 and a second value (for example, density value Afi) obtained from the second pattern section PP2 included in the captured image IM0.

By averaging the first value (Aei) obtained from the first pattern section PP1 included in the captured image IM0 and the second value (Afi) obtained from the second pattern section PP2 included in the captured image IM0, errors in the ‘adjustment value of the printing density’ (G3i) due to peripheral dimming occurring in the captured image IM0 are reduced. Therefore, the above-described aspect can provide a printing system suitable for reducing the error in the adjustment value of the printing density due to peripheral dimming occurring in the captured image. The adjustment value (G3i) may be determined by the control section 110 or a printing device 2.

Furthermore, the aspect described above can be applied to a computer-readable non-transitory medium in which the imaging control program described above is recorded, the information terminal described above, a control method of the information terminal, a printing method performed by the printing system described above, a control program of printing system described above, a computer-readable non-transitory medium in which the control program is recorded, and the like. Any of the foregoing devices may be comprised of a plurality of distributed portions.

### (2) Specific Example of Imaging Control Program

FIG. 1 schematically illustrates the printing system SY1 including the information terminal 1 and the printing device 2. FIG. 2 schematically illustrates the configuration of the printing system SY1. FIGS. 3, 4A to 4C schematically illustrate the test pattern TP0.

Examples of the information terminal 1 include a mobile phone such as a smartphone, a tablet terminal, and a digital camera. The information terminal 1 may be configured as a plurality of devices that can communicate with each other, or as a stationary type device with a position-changeable imaging section coupled to it. The printing device 2 is assumed to be an inkjet printer including the recording head 220 capable of ejecting droplets 280. Of course, the printing device 2 may be a thermal printer (including a thermal transfer printer) provided with a thermal head as a recording head, an electrophotographic printer (for example, a laser printer) including a recording head that causes toner to adhere to a medium ME0, a three-dimensional printer, or the like may be used. The printing device 2 may be configured as the plurality of devices that can communicate with each other.

The printing device 2 can form a print image PI0 including the density pattern DP0 for adjusting the printing density of the printing device 2 on the medium ME0. A user US1 can adjust the printing characteristics of the printing device 2 by imaging the test pattern TP0 with the information terminal 1 including the imaging section 120. In the captured image IM0, peripheral dimming may occur due to the structure of the imaging section 120. Peripheral dimming is a phenomenon in which the light passing through the lens at the time of imaging is bright at the center of the optical axis, and the light becomes darker as the distance from the center increases and is also referred to as insufficiency of a luminous quantity around an image. Due to this phenomenon, the captured image IM0 may become darker toward the periphery of the image. In particular, when the information terminal 1 is a thin terminal such as a smartphone, the housing space of the imaging section 120 is limited, and thus peripheral dimming is likely to occur. On the other hand, when the terminal is not thin, the influence of peripheral dimming occurs although the influence is smaller than that of the thin terminal. Therefore, the arrangement region ARI of the density pattern DP0 included in the test pattern TP0 shown in FIG. 3 is symmetrically arranged on the assumption that peripheral dimming occurs. The arrangement region AR1 of the density pattern DP0 is symmetrical with respect to either the center CT1 of the imaging target region AR0 or the symmetry axis AX0 passing through the center CT1 as the reference. Here, in a case where user US1 captures an image of the test pattern TP0 by holding the information terminal 1 by hand, there is a possibility that the center CT1 of the imaging target region AR0 shifts from the angle of view of the imaging section 120, that is, from the center of the imaging range. Therefore, the imaging control program PR0 illustrated in FIG. 2 causes the imaging section 120 to automatically perform imaging with the satisfaction of the imaging condition as a trigger, thereby causing the information terminal 1 to realize appropriate imaging of the test pattern TP0. The imaging condition includes at least a condition that the center CT1 of the imaging target region AR0 is within the predetermined central region CA1 in the angle of view FA. It can be said that the information terminal 1 that executes the imaging control program PR0 realizes an automatic shutter system.

Note that even if the information terminal 1 is not portable but is a stationary type device, the imaging control program PR0 may be executed when the relative positional relationship with the test pattern TP0 changes, for example.

A communication interface (I/F) 117 of the information terminal 1 can communicate with the communication I/F 230 of the printing device 2. The information terminal 1 can transmit the adjustment values and the like of the printing characteristics to the printing device 2 via the communication I/Fs 117, 230. Upon receiving the adjustment value, the printing device 2 stores the adjustment value and adjusts the printing characteristics based on the adjustment value. The communication I/Fs 117, 230 may be wireless communications conforming to the standard of a wireless local area network (LAN), wired communications, or network communications such as the Internet.

The information terminal 1 illustrated in FIG. 2 includes the control section 110, a storage section 114, an operation section 115, a display section 116, the communication I/F 117, and the imaging section 120. The information terminal 1 may include a sensor SS1 and a sensor SS2 coupled with the control section 110. The control section 110 includes a central processing unit (CPU) 111 as processor, a read-only memory (ROM) 112, and the random access memory (RAM) 113. The RAM 113 is an example of a memory for storing the captured image IM0 obtained from the imaging section 120.

The storage section 114 stores the imaging control program PR0 for imaging the test pattern TP0 and the like. As the storage section 114, a non-volatile semiconductor memory such as flash memory can be used. The storage section 114 may be removably attached to the main body of the information terminal 1. The display section 116 displays a screen corresponding to the display information based on the display information. A liquid crystal display panel or the like can be used for the display section 116. As the operation section 115, a touch panel attached to the surface of the display section 116, a hard key, or the like can be used. The display section 116 displays a screen corresponding to the display information based on the display information.

The imaging control program PR0 causes the information terminal 1 to realize the determination function FU1, the imaging control function FU2, and adjustment value decision function FU3. The CPU 111 reads information stored in the storage section 114 to the RAM 113 as appropriate and performs various processes by executing the read program. The CPU 111 performs processes corresponding to the above-described functions (FU1 to FU3) by executing the imaging control program PR0 read into the RAM 113. The information terminal 1 that executes the imaging control program PR0 performs a judgement process corresponding to the determination function FU1, an imaging control process corresponding to the imaging control function FU2, and an adjustment value determination process corresponding to the adjustment value decision function FU3. A computer-readable medium storing the imaging control program PR0 that causes a computer to realize the above-described functions (FU1 to FU3) is not limited to the storage section 114 and may be a storage medium outside the information terminal 1.

The imaging section 120 includes a lens 121, an autofocus (AF) unit 122, an image sensor 123, and the like. The image sensor 123 converts an image of light incident via the lens 121 and the AF unit 122 into an electric signal. In this specific example, the image sensor 123 outputs digital data corresponding to an electric signal of each light receiving element. The digital data is stored in the RAM 113 as a frame FR0 or the captured image IM0. As the image sensor 123, a Complementary Metal-Oxide Semiconductor (CMOS) image sensor, a Charge Coupled Devices (CCD) image sensor, or the like can be used.

The sensors SS1 and SS2 can be used to judge whether or not the imaging condition is satisfied. For example, the sensor SS1 may be a speed sensor that measures the movement speed of the imaging section 120 or may be an acceleration sensor that measures the accelerations of the imaging section 120. In this case, it is possible to detect the magnitude of the blur of the captured image IM0 based on the measurement value by the sensor SS1. The sensor SS2 may be a distance-measuring sensor that measures the distances from the imaging section 120 to the medium ME0. In this case, it is possible to detect the distances from the imaging section 120 to the medium ME0 based on the measured values by the sensor SS2.

The printing device 2 ejects cyan (C) ink, magenta (M) ink, yellow (Y) ink, and black (K) ink as color materials from the recording head 220 as droplets 280 to form the print image PI0 corresponding to printing data. The recording head 220 includes a plurality of nozzles Nc capable of ejecting C ink droplets onto the medium ME0, a plurality of nozzles Nm capable of ejecting M ink droplets onto the medium ME0, a plurality of nozzles Ny capable of ejecting Y ink droplets onto the medium ME0, and a plurality of nozzles Nk capable of ejecting K ink droplets onto the medium ME0. Inks of C, M, Y, and K are supplied to the recording head 220 from ink cartridges Cc, Cm, Cy, and Ck, respectively. The recording head 220 ejects the droplets 280 of C, M, Y, and K from the nozzles Nc, Nm, Ny, and Nk, respectively, according to the control of a controller 210. When droplets 280 land on the medium ME0, an ink dot is formed on the medium ME0. The printing device 2 includes a drive section that changes the relative positional relationship between the recording head 220 and the medium ME0 according to the control of the controller 210, for example, a transport section 225 that transports the medium ME0 in a predetermined transport direction. As a result, printed matter with a pattern of ink dots as the print image PI0 on the medium ME0 is obtained. The material of the medium ME0 is not particularly limited and may be paper, fabric, resin, metal, or the like. The shape of medium ME0 may be a cut two-dimensional shape, a roll shape, or a three-dimensional shape.

The test pattern TP0 shown in FIG. 3 includes a plurality of density patterns DP0, a plurality of finder patterns MK0, and the imaging direction indicating pattern IP1. A plurality of density patterns DP0 are arranged vertically with respect to the imaging target region AR0. The finder patterns MK0 are arranged on the medium ME0 at corner sections C0 of a rectangle including the plurality of density patterns DP0. When the finder patterns MK0 are arranged at the four corner sections of the rectangle, the imaging target region AR0 is a rectangular region on the medium ME0, having the four finder patterns MK0 as the four corner sections C0. In FIG. 3, a rectangular imaging target region AR0 with the vertical sides S1 and S2 and the horizontal sides S3 and S4 is indicated by a two-dot chain line. As the finder pattern MK0, a square ArUco marker with a specific geometric feature, a triangular pattern, or the like can be used. The imaging direction indicating pattern IP1 shows the direction of imaging.

When the finder pattern MK0 is not present on the medium ME0, the medium ME0 itself becomes the imaging target region AR0. In this case, the medium ME0 is preferably cut as are cut sheets and preferably has a rectangular shape, although this is not a limitation.

In FIG. 3, symmetry axes AX1 along the horizontal sides S3 and S4 and symmetry axes AX2 along the vertical sides S1 and S2 are shown in the rectangular imaging target region AR0. Note that the symmetry axis AX0 collectively refers to the symmetry axes AX1 and AX2 and indicates axes extending along the direction of the sides (S1 to S4) of the rectangle. The intersection of the symmetry axis AX1 and a symmetry axis AX2 is the center CT1 of the imaging target region AR0. The plurality of density patterns DP0 shown in FIG. 3 include a first pattern DP1 and a second pattern DP2 that both have the same shape and that do not intersect the symmetry axis AX1, which is along the horizontal sides S3 and S4, but that intersect the symmetry axis AX2, which is along the vertical sides S1 and S2. The first pattern DP1 corresponds to the first pattern section PP1 of the density pattern DP0, and the second pattern DP2 corresponds to the second pattern section PP2 of the density pattern DP0. The arrangement region of the first pattern DP1 and the arrangement region of the second pattern DP2 are line-symmetric with respect to the symmetry axis AX1, which is along the horizontal sides S3 and S4, as the reference. The arrangement region of the first pattern DP1 and the arrangement region of the second pattern DP2 are also line-symmetric with respect to the symmetry axis AX2, which is along the vertical sides S1 and S2, as the reference. As a result, the arrangement region of the first pattern DP1 and the arrangement region of the second pattern DP2 are point-symmetrical with respect to the center CT1 as the reference. It can be said that the arrangement region AR1 of the density pattern DP0 within the imaging target region AR0 is line-symmetric with respect to the symmetry axis AX0 as the reference, and point-symmetric with respect to the center CT1 as the reference.

Note that the arrangement region ARI being symmetrical with respect to at least one of the center CT1 or the symmetry axis AX0 as the reference, means focusing on only the shape of the region. Therefore, when each density pattern DP0 includes a plurality of individual patterns, the plurality of individual patterns in the first pattern DP1 and the plurality of individual patterns in the second pattern DP2 do not need to be arranged symmetrically.

The test pattern TP0 shown in FIG. 4A includes the plurality of density patterns DP0, a plurality of finder patterns MK0, and the imaging direction indicating pattern IP1. The plurality of density patterns DP0 shown in FIG. 4A are arranged horizontally with respect to the imaging target region AR0, and do not intersect with the symmetry axis AX2, which is along the vertical sides S1 and S2, but intersect with the symmetry axis AX1 (see FIG. 3), which is along the horizontal sides S3 and S4. The first pattern DP1 corresponds to the first pattern section PP1 of the density pattern DP0, and the second pattern DP2 corresponds to the second pattern section PP2 of the density pattern DP0. The arrangement region of the first pattern DP1 and the arrangement region of the second pattern DP2 are line-symmetric with respect to the symmetry axis AX2, which is along the vertical sides S1 and S2, as the reference. The arrangement region of the first pattern DP1 and the arrangement region of the second pattern DP2 are also line-symmetric with respect to the symmetry axis AX1 (see FIG. 3), which is along the horizontal sides S3 and S4, as the reference. As a result, the arrangement region of the first pattern DP1 and the arrangement region of the second pattern DP2 are point-symmetrical with respect to the center CT1 as the reference.

As shown in FIGS. 3 and 4A, when the imaging target region AR0 is a rectangle with long sides (the vertical sides S1 and S2) and short sides (the horizontal sides S3 and S4), the arrangement region AR1 for the plurality of density patterns DP0 within the imaging target region AR0 is preferably as shown in FIG. 3 rather than in FIG. 4A. When the arrangement region AR1 of the plurality of density patterns DP0 is divided into two by the symmetry axis AX1, which is along the short sides (horizontal sides S3 and S4), the density patterns DP0 are not divided in the direction along the short side (horizontal sides S3 and S4) by the symmetry axis AX0. Thus, when the arrangement region ARI is divided into two by the symmetry axis AX1, the density pattern DP0 can be made longer in the direction along the short sides (horizontal sides S3 and S4). As a result, it is possible to further reduce error in the adjustment value of the printing density due to peripheral dimming. This effect is particularly great in a case where the printing device 2 is a serial type and the main scanning direction is along a short side of the medium ME0.

In addition, it can be said that the imaging direction indicating pattern IP1 illustrated in FIG. 3 indicates the direction of imaging such that imaging is performed by the imaging section 120 in a state where the long sides (the vertical sides S1 and S2) are oriented vertically. The user US1 can grasp the direction of the test pattern TP0 at the time of imaging by viewing the imaging direction indicating pattern IP1.

The test pattern TP0 shown in FIG. 4B includes one density pattern DP0, a plurality of finder patterns MK0, and the imaging direction indicating pattern IP1. The density pattern DP0 shown in FIG. 4B is located at a position including the center CT1 in the imaging target region AR0, intersects with the symmetry axis AX1, which is along the horizontal sides S3 and S4, and also intersects with the symmetry axis AX2, which is along the vertical sides S1 and S2 (see FIG. 3). The longitudinal direction of the density pattern DP0 is along the symmetry axis AX1, which is along the horizontal side S3 and S4. In the density pattern DP0, a portion above the symmetry axis AX1 corresponds to the first pattern section PP1, and a portion below the symmetry axis AX1 corresponds to the second pattern section PP2. The arrangement region of the first pattern section PP1 and the arrangement region of the second pattern section PP2 are line-symmetric with respect to the symmetry axis AX1, which is along the horizontal sides S3 and S4, as the reference. The arrangement region of the first pattern section PP1 and the arrangement region of the second pattern section PP2 are line-symmetric with respect to the symmetry axis AX2 (refer to FIG. 3), which is along the vertical sides S1 and S2, as the reference. As a result, the arrangement region of the first pattern section PP1 and the arrangement region of the second pattern section PP2 are point-symmetric with respect to the center CT1 as the reference.

The test pattern TP0 shown in FIG. 4C includes one density pattern DP0, the plurality of finder patterns MK0, and the imaging direction indicating pattern IP1. The density pattern DP0 shown in FIG. 4C is located at a position including the center CT1 in the imaging target region AR0, intersects with the symmetry axis AX2, which is along the vertical sides S1 and S2, and also intersects with the symmetry axis AX1 (see FIG. 3), which is along the horizontal sides S3 and S4. The longitudinal direction of the density pattern DP0 has a direction along the symmetry axis AX2, which is along the vertical sides S1 and S2. In the density pattern DP0, a portion on the left side of the symmetry axis AX2 corresponds to the first pattern section PP1, and a portion on the right side of the symmetry axis AX1 corresponds to the second pattern section PP2. The arrangement region of the first pattern section PP1 and the arrangement region of the second pattern section PP2 are line-symmetrical with respect to the symmetry axis AX2, which is along the vertical sides S1 and S2, as the reference. The arrangement region of the first pattern section PP1 and the arrangement region of the second pattern section PP2 are line-symmetric with respect to the symmetry axis AX1 (refer to FIG. 3), which is along the horizontal sides S3 and S4, as the reference. As a result, the arrangement region of the first pattern section PP1 and the arrangement region of the second pattern section PP2 are point-symmetric with respect to the center CT1 as the reference.

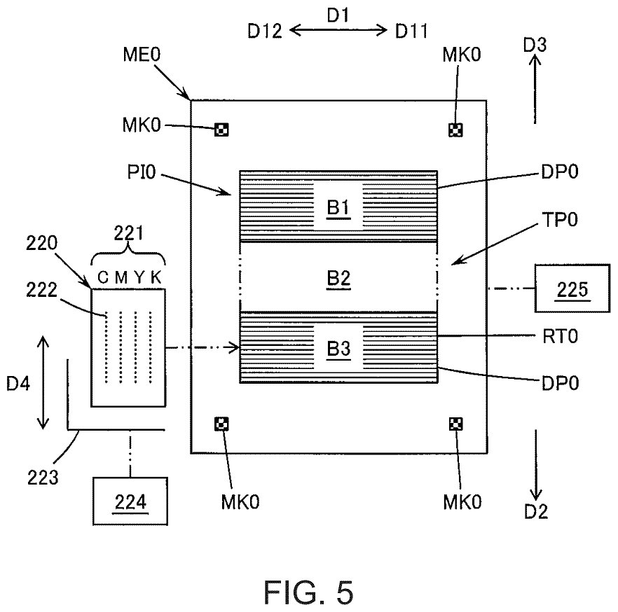

FIG. 5 schematically illustrates an example of the recording head 220 and the density pattern DP0 in a case where the printing device 2 is a serial printer. The recording head 220 includes, on a nozzle surface, a nozzle array 221 in which a plurality of nozzles 222 capable of ejecting droplets 280 onto the medium ME0 are arranged at intervals of a predetermined nozzle pitch in an arranged direction D4. Here, nozzle means a small hole from which liquid droplets are ejected, and nozzle array means an arrangement of multiple nozzles. The nozzle array 221 includes, for example, a nozzle array capable of ejecting the C droplets 280, a nozzle array capable of ejecting the M droplets 280, a nozzle array capable of ejecting the Y droplets 280, and a nozzle array capable of ejecting the K droplets 280. The serial type printing device 2 includes a carriage 223 on which the recording head 220 is mounted, a carriage drive section 224 including a servo motor, and the transport section 225 including a servo motor.

The controller 210 reciprocates the carriage 223 along the main scanning direction D1 by controlling the driving of the carriage drive section 224 and feeds the medium ME0 in a feeding direction D3 by controlling the driving of the transport section 225. The main,scanning direction D1 is a direction intersecting the arranged direction D4 of nozzles 222 in the nozzle array 221, and is, for example, a direction orthogonal to the arranged direction D4. FIG. 5 shows that the right direction is a going-main-scanning direction D11, and the left direction is a returning-main-scanning direction D12. The direction D3 is a direction feeding intersecting the main scanning direction D1, and is, for example, a direction orthogonal to the main scanning direction D1. A sub-scanning direction D2 shown in FIG. 5 is a direction opposite to the feeding direction D3. Although the carriage 223 shown in FIG. 5 does not move in the sub-scanning direction D2, sub-scanning may be realized by a sub-scanning drive section (not shown) moving the carriage 223 in the sub-scanning direction D2.

For example, when the printing device 2 performs band printing, the print image PI0 is formed in a unit of a band in order of the sub-scanning direction D2. In FIG. 5, after the density pattern DP0 for adjusting the printing density in a unit of the nozzle 222 in the nozzle array 221 is formed in a band B1, the band B2 is left blank and then the density pattern DP0 is formed in the band B3. Each density pattern DP0 has a raster RT0 corresponding to each nozzle 222 in the nozzle array 221. The printing density of each nozzle 222 appears as the darkness of the dot row of the raster RT0. The order of the nozzle 222 corresponding to the raster RT0 of the density pattern DP0 in the sub-scanning direction D2 is the same in the band B1 and the band B3. Therefore, the plurality of density patterns DP0 are arranged in the sub-scanning direction D2. When the test pattern TP0 includes the plurality of finder patterns MK0 and the like, these patterns may be formed in a band different from bands B1 to B3.

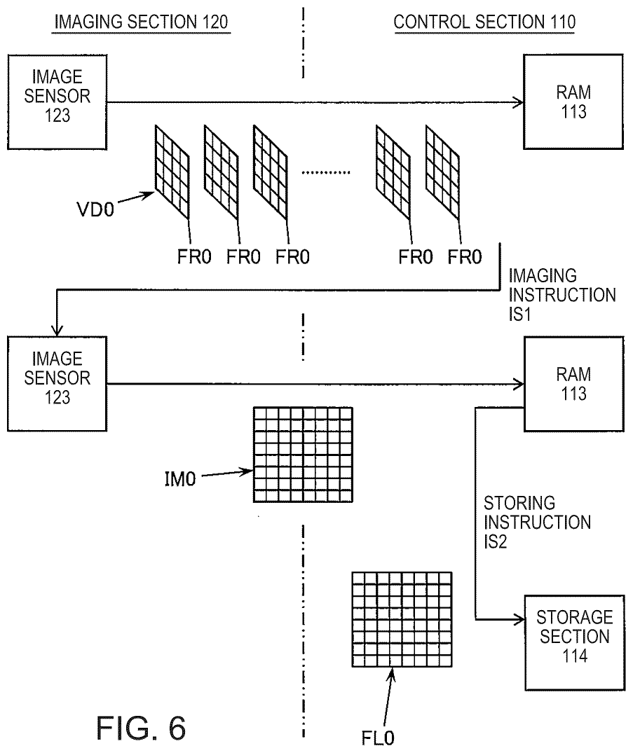

Next, an operation example of the information terminal 1 at the time of imaging will be described with reference to FIG. 6. In general, imaging is triggered by an operation on a shutter button included in the operation section 115.

The frame FR0 constituting a video VD0 is transferred from the image sensor 123 of the imaging section 120 to the RAM 113 of the control section 110 for each frame period. At this time, the CPU 111 may store the frame FR0 in the RAM 113, or a DMA controller (not shown) may store the frame FR0 in the RAM 113. Each frame FR0 represents a still image for each frame period but may have a difference from the previous frame as information. Due to the processing capability of the information terminal 1, each frame FR0 has a lower resolution than the captured image IM0. It can also be said that the frame FR0 has a smaller number of pixels than the captured image IM0. The control section 110 controls the AF unit 122 and the like based on the frame FR0 group. The control section 110 may cause the display section 116 to display each frame FR0.

When the user US1 performs an operation of pressing or touching the shutter button, the operation section 115 receives the operation, and the operation section 115 notifies the control section 110 that the shutter button has been operated. Then, the control section 110 commands an imaging instruction IS1 to the imaging section 120 to cause the imaging section 120 to execute imaging. The captured image IM0 generated by this imaging has a resolution higher than that of frame FR0 and is stored in the RAM 113. Here, the CPU 111 may perform the process of storing the captured image IM0 in the RAM 113, or the DMA controller (not illustrated) may perform the process of storing the captured image IM0 in the RAM 113.

When the user US1 performs an operation of saving the captured image IM0, the operation section 115 receives the operation, and the operation section 115 notifies the control section 110 of a storing instruction IS2. Then, the control section 110 stores the captured image IM0 in the format of a file FL0 in the storage section 114. That is, the storage section 114 stores the file FL0. Examples of the file format include a JPEG (Joint Photographic Experts Group) format, a Bitmap format, and the like. Note that the control section 110 may accept settings including the file format, the resolution of the captured image IM0 that is included in the file FL0, and the like via the operation section 115, and store the file FL0 according to the settings in the storage section 114. The captured image IM0 being stored in the RAM 113 may serve as a trigger that causes the control section 110 to automatically generate the file FL0 of the captured image IM0 and store the file FL0 in the storage section 114.

However, peripheral dimming may occur in the captured image IM0 of the test pattern TP0. If the zoom is performed to a level at which peripheral dimming does not cause a problem, the entire test pattern cannot be captured at once, and it becomes necessary to capture the test pattern TP0 many times. Therefore, it takes time to adjust the printing density, and a large amount of memory is required to store the captured image IM0. Therefore, in this specific example, the density patterns DP0 are symmetrically arranged in the imaging target region AR0 to reduce the error in the adjustment value of the printing density.

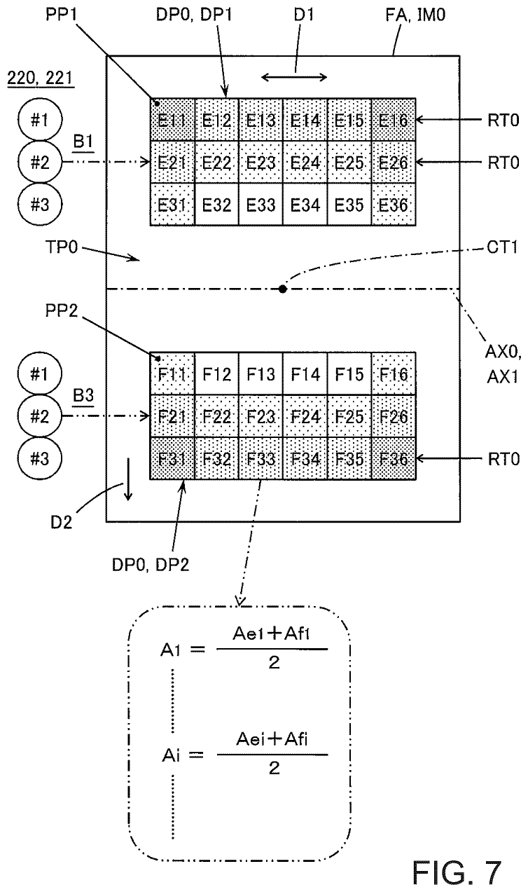

FIG. 7 schematically exemplifies the density values obtained from the captured image IM0 of the test pattern TP0, and the density pattern DP0. FIG. 7 is merely a schematic diagram, and a certain nozzle array 221 of the recording head 220 includes nozzles #1, #2, and #3 as the nozzles 222, the first pattern DP1 of the band B1 includes regions E11 to E36, and the second pattern DP2 of the band B3 includes regions F11 to F36. Actually, the number of nozzles 222 included in the nozzle array 221 is much larger than three. The density pattern DP0 included in the captured image IM0 is, as shown in FIGS. 3 and 5, a captured image of the density pattern DP0 included in the test pattern TP0 that is arranged vertically long with the imaging direction indicating pattern IP1 facing upward. Therefore, the captured image IM0 is vertically elongated, the main scanning direction D1 is horizontal, and the sub-scanning direction D2 is vertical.

When the density pattern DP0 is printed, the nozzle #1 ejects droplets 280 to the raster RT0 of the regions E11 to E16 in the band B1 and ejects droplets 280 to the raster RT0 of the regions F11 to F16 in the band B3. Therefore, the dot rows of droplets 280 from the nozzle #1 are formed in the raster RT0 of the regions E11 to E16 and F11 to F16. In addition, the nozzle #2 ejects the droplets 280 to the raster RT0 of the regions E21 to E26 in the band B1 and ejects the droplets 280 to the raster RT0 of the regions F21 to F26 in the band B3. Therefore, the dot rows of the droplets 280 from the nozzle #2 are formed in the raster RT0 of the regions E21 to E26 and F21 to F26. Further, the nozzle #3 ejects droplets 280 to the raster RT0 of regions E31 to E36 in the band B1 and ejects droplets 280 to the raster RT0 of regions F31 to F36 in the band B3. Therefore, the dot rows of droplets 280 from the nozzle #3 are formed in the raster RT0 of the regions E31 to E36 and F31 to F36. For convenience of illustration, each of the regions E11 to E36 and F11 to F36 is illustrated as a square, but the region corresponding to each of the plurality of nozzles 222 included in the nozzle array 221 may be formed in a linear shape along the main scanning direction D1.

For convenience of description, the density value of the raster RT0 in the region E11 to E16 is defined as Ae1, the density value of the raster RT0 in the region E21 to E26 is defined as Ae2, and the density value of the raster RT0 in the region E31 to E36 is defined as Ae3. Similarly, the density value of the raster RT0 in the region F11 to F16 is defined as Af1, the density value of the raster RT0 in the region F21 to F26 is defined as Af2, and the density value of the raster RT0 in the region F31 to F36 is defined as Af3. A variable for identifying the raster RT0 included in the first pattern DP1 and the second pattern DP2 is defined as i, the density value of the i-th raster RT0 of the regions E11 to E36 is defined as Aei, and the density value of the i-th raster RT0 of the regions F11 to F36 is defined as Afi. The density values Aei and Afi are obtained based on the pixel values of the captured image IM0 obtained by imaging the density pattern DP0.

Peripheral dimming occurs according to the angle of view FA, that is, the distance from the center of the captured image IM0. FIG. 7 shows that the center CT1 of the imaging target region AR0 of the test pattern TP0 is aligned with the center of the captured image IM0. In this case, the influence of peripheral dimming is small on the raster RT0 in regions E31 to E36 and F11 to F16, and the influence of peripheral dimming is large on the raster RT0 in regions E11 to E16 and F31 to F36. Therefore, for the regions E11 to E16 and F11 to F16 corresponding to the nozzle #1, relatively dark density values Ae1 and relatively bright density values Af1 are obtained. For the regions E31 to E36 and F31 to F36 corresponding to nozzle #3, relatively bright density values Ae3 and relatively dark density values Af3 are obtained. For the regions E21 to E26 and F21 to F26 corresponding to nozzle #2, intermediate bright density values Ae3 and Af3 are obtained. Therefore, in order to reduce the influence of peripheral dimming on the adjustment value of the printing density for each nozzle, average values A1=(Ae1+Af1)/2, A2=(Ae2+Af2)/2, and A3=(Ae3+Af3)/2 can be used. A1 means average value of Ae1 and Af1, A2 means average value of Ae2 and Af2, and A3 means average value of Ae3 and Af3. In general, by using the average value Ai of the density values Aei and Afi, that is, Ai=(Aei+Afi)/2, it is possible to reduce the influence of peripheral dimming on the adjustment value of the printing density of the nozzle array 221.

Note that depending on the method of adjusting the printing density, it is also possible to obtain the average value of the density values by dividing the region in each raster RT0. For example, a variable for identifying a region in the raster RT0 is set as j, the density value of region Eij is set as Aeij, and the density value of region Fij is set as Afij. By using the average value Aij of the density values Aeij and Afij, that is, Aij=(Aeij+Afij)/2, the influence of peripheral dimming on the adjustment value of the printing density of the recording head 220 can be reduced.

By the way, when the test pattern TP0 is imaged, the center CT1 of the imaging target region AR0 may be shifted from the center of the angle of view of the imaging section 120. Therefore, in this example, imaging is automatically performed with the satisfaction of the imaging condition including at least the condition that the center CT1 of the imaging target region AR0 is within the predetermined central region CA1 in the angle of view FA as a trigger.

### (3) Specific Example of Imaging Control Process

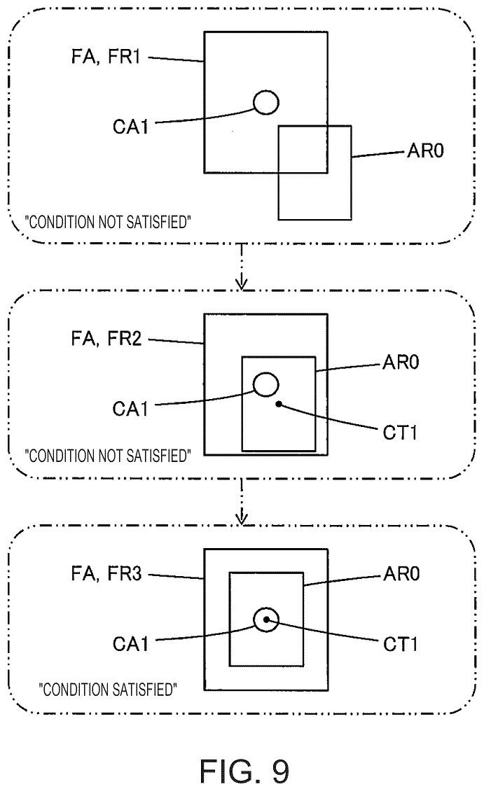

FIG. 8 schematically illustrates an example of the imaging control process performed by the control section 110. Here, steps S102 to S106 correspond to the determination function FU1, and step S110 corresponds to the imaging control function FU2. Hereinafter, the word “step” may be omitted, and reference numeral of steps may be indicated in parentheses. The imaging control process is started when the control section 110 receives an imaging instruction for the imaging target region AR0 via the operation section 115. The imaging instruction may be an operation on an imaging instruction region displayed after the imaging control program PR0 is activated, an operation on a shutter button, an activation operation of the imaging control program PR0, or the like. FIG. 9 schematically shows an example of whether or not the condition that the center CT1 of the imaging target region AR0 is within the central region CA1 of the angle of view FA is satisfied.

The user US1 activates the imaging control program PR0 and performs an operation of imaging the imaging target region AR0 of the test pattern TP0 by the information terminal 1 with the imaging direction indicating pattern IP1 shown in FIG. 3 facing upward. When the imaging control process is started by the activation of the imaging control program PR0, the control section 110 determines whether or not a new frame FRO has been transferred from the image sensor 123 to the RAM 113 (S102). The determination process of S102 is repeated until a new frame FR0 is transferred. It can be said that the determination process of S102 is a process of determining whether or not a new frame FRO is acquired from the imaging section 120.

When the new frame FR0 is transferred, the control section 110 acquires the coordinates of the center CT1 of the imaging target region AR0 based on the frame FRO (S104). The coordinates of the center CT1 can be obtained based on the coordinates of the four corner sections of the imaging target region AR0 in frame FR0, for example, by averaging the coordinates of the four corner sections of the imaging target region AR0. Details of the process of S104 will be described later together with the determination process of S106.

After acquiring the coordinates of center CT1, the control section 110 determines whether or not the imaging condition is satisfied based on the coordinates of center CT1 (S106). As shown in FIG. 9, the imaging condition includes an alignment condition in which the center CT1 of the imaging target region AR0 is within the predetermined central region CA1 in the angle of view FA of the imaging section 120. The central region CA1 is a region slightly expanding from the strict center of the angle of view FA and is circular in FIG. 9. The central region CA1 is set to a range in which errors in the adjustment value of the printing density due to peripheral dimming are allowed. When the central region CA1 is narrowed, errors in the adjustment value of the printing density due to peripheral dimming are reduced.

If the image imaging condition is not satisfied, the control section 110 displays, a guidance (S108) such as one that indicates the sentence “Please align the center of the test pattern with the center of the screen.” for satisfying the imaging condition, and the process is returned to S106. Accordingly, the processes from S102 to S108 is repeated until the imaging condition is satisfied, and the control section 110 repeatedly acquires the frame FR0 from the imaging section 120 and repeatedly acquires the coordinates of the center CT1 of the imaging target region AR0. The output of the guidance may be a display on the display section 116, a voice output to a voice output unit (not illustrated), or the like.

Here, details of the processes from S104 to S106 will be described with reference to FIG. 9. FIG. 9 illustrates a state in which frames FR1 to FR3 as frame FR0 are acquired in order of time.

As a premise for acquiring the coordinates of center CT1, an inclusion condition that the imaging target region AR0 is included in the angle of view FA of the imaging section 120 needs to be satisfied. Whether or not the inclusion condition is satisfied can be determined by determining whether or not the imaging target region AR0 is completely included in the frame FR0 corresponding to the angle of view FA.

For example, it is assumed that the medium ME0 has the finder pattern MK0 (see FIG. 3) at the four corner sections of the imaging target region AR0. In this case, the control section 110 can determine that the inclusion condition is satisfied if the four finder patterns MK0 can be detected from the frame FR0. The control section 110 can determine that the inclusion condition is not satisfied when even one of the four finder patterns MK0 cannot be detected from the frame FR0.

When the medium ME0 does not have the finder pattern MK0, the medium ME0 itself serves as the imaging target region AR0. When the medium ME0 has a rectangular shape, the control section 110 may detect a plurality of edges from the frame FR0 and may determine that the inclusion condition is satisfied when a quadrangle surrounded by two edges determined to be vertically oriented and two edges determined to be horizontally oriented is detected. Since there is a possibility that the medium ME0 included in the frame FR0 is tilted, the “vertical direction” is a direction that includes a deviation from a strict vertical direction within a range of a predetermined allowable angle, and the “horizontal direction” is a direction that includes a deviation from a strict horizontal direction within a range of a predetermined allowable angle. For recognition of the medium ME0 from frame FR0, known rectangle recognition such as business card recognition can be applied.

As described above, the control section 110 determines whether or not the inclusion condition is satisfied based on the frame FR0 repeatedly acquired from the imaging section 120. When the inclusion condition is not satisfied, then in S108 shown in FIG. 8, the control section 110 may output the guidance for satisfying the inclusion condition. As an example, the guidance output may display information such as “Please put the entire test pattern on the screen,” or it may be provided via voice.

The frame FR1 shown in FIG. 9 includes only a part of the imaging target region AR0. In this case, the control section 110 determines that the imaging condition, including at least the alignment condition, is not satisfied.

The frame FR2 shown in FIG. 9 includes the entire imaging target region AR0. In t this case, the control section 110 determines that the inclusion condition is satisfied and obtains the coordinates of the center CT1 of the imaging target region AR0 by averaging the coordinates of the four corner sections of the imaging target region AR0 in the frame FR2. In addition, the control section 110 determines whether the center CT1 of the imaging target region AR0 is included in the central region CA1 of the angle of view FA. Since the center CT1 is not included in the central region CA1 of the frame FR2, the control section 110 determines that the imaging condition including at least the alignment condition is not satisfied.

The frame FR3 shown in FIG. 9 includes the entire imaging target region AR0. The control section 110 determines that the inclusion condition is satisfied, similarly obtains the coordinates of the center CT1 of the imaging target region AR0 and determines whether or not the center CT1 of the imaging target region AR0 is included in the central region CA1 of the angle of view FA. Since the frame FR3 includes the center CT1 in the central region CA1, the control section 110 determines that the imaging condition, including at least the alignment condition, is satisfied.

The imaging condition may be a condition that satisfies at least the alignment condition and an additional condition other than the alignment condition. The additional conditions may include at least one of the following: a second condition where the amount of change in the relative positional relationship between the imaging section 120 and the medium ME0 is less than or equal to a reference change amount; a third condition where the imaging section 120 is within a predetermined facing range with respect to the imaging target region AR0; a fourth condition where the amount of distortion indicating the distortion of the density pattern DP0 included in the frame FR0 is less than or equal to a reference distortion amount; a fifth condition where the distance amount corresponding to the distance between the imaging section 120 and the medium ME0 is less than or equal to a reference distance amount; and a sixth condition where the brightness amount indicating the brightness L of the background color of the medium ME0 is greater than or equal to a reference brightness amount.

When the imaging condition is satisfied, the control section 110 acquires the captured image IM0 by causing the imaging section 120 to perform imaging of the imaging target region AR0 (S110). At this time, the CPU 111 may store the captured image IM0 from the image sensor 123 in the RAM 113, or the DMA controller may store the captured image IM0 from the image sensor 123 in the RAM 113. The captured image IM0 has a higher resolution than frame FRO.

As described above, with satisfaction of the imaging condition including the alignment condition as a trigger, the control section 110 acquires the captured image IM0 by causing the imaging section 120 to execute imaging of the imaging target region AR0.

After the captured image IM0 is acquired, the control section 110 determines whether or not to store the captured image IM0 as file FL0 (S112). For example, when the operation section 115 receives an operation of storing the captured image IM0, the control section 110 stores the captured image IM0 in the format of file FL0 in the storage section 114 (S114) and ends the imaging control process. That is, the storage section 114 stores the file FL0. When the operation section 115 receives an operation to discard the captured image IM0, the control section 110 ends the imaging control process without performing the S114 saving process.

In S112, the control section 110 may determine whether or not the test pattern TP0 included in the captured image IM0 is appropriate for the adjustment of the printing characteristics.

In this case, the control section 110 may perform a process of saving as the S114 when it is determined to be appropriate or may return the process to the S102 when it is determined to be inappropriate. This is because there is a time lag until actual imaging even when the imaging condition is satisfied. Further, the control section 110 may automatically generate the file FL0 of the captured image IM0 and store the file FL0 in the storage section 114 by performing the process of S114 without performing the determination process of S112 and using the storage of the captured image IM0 in the RAM 113 as a trigger.

The control section 110 can acquire an adjustment value for adjusting the printing density of the printing device 2 based on the pixel value of the density pattern DP0 included in the captured image IM0 and can cause the printing device 2 to print an image having a density according to the adjustment value.

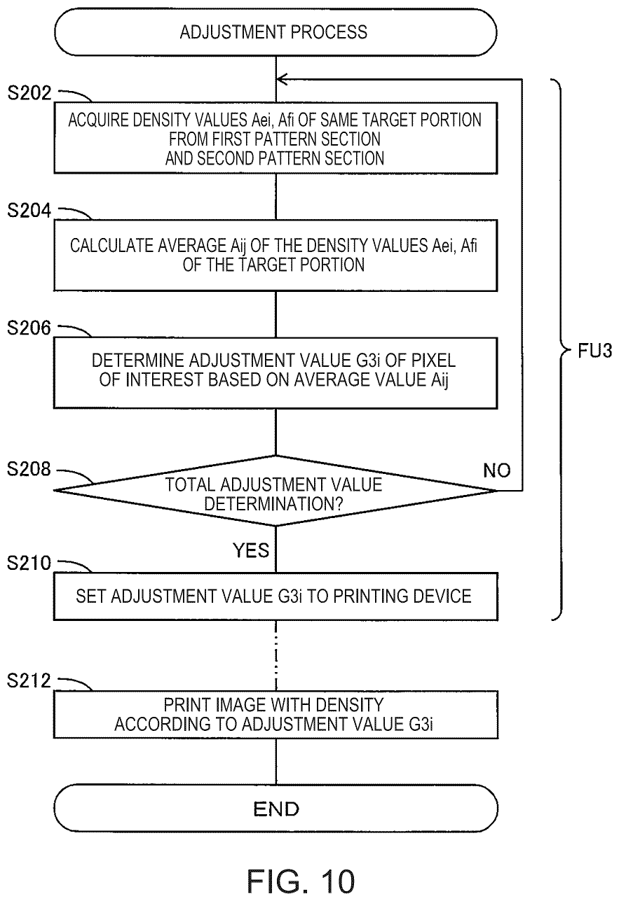

FIG. 10 schematically shows an example of the adjustment process performed by the control section 110. Here, the steps S202 to S210 correspond to the adjustment value decision function FU3. The adjustment process is started when the control section 110 receives a printing density adjustment instruction via the operation section 115. The adjustment instruction may be an operation on the adjustment instruction region displayed after the end of the imaging control process illustrated in FIG. 8 or may be an operation on the adjustment instruction region displayed immediately after the activation of the imaging control program PR0. FIG. 11 schematically illustrates an example of acquiring the adjustment value G3i of the printing density for the i-th nozzle 222.

When the adjustment process is started, the control section 110 sets the same target location from the plurality of rasters RT0 for the first pattern section PP1 and the second pattern section PP2. In addition, the control section 110 acquires the density values Aei and Afi of the same target location based on the pixel value of the captured image IM0 of the density pattern DP0 (S202). In the example shown in FIG. 7, the density value Aei of the i-th raster RT0 of the first pattern DP1 is acquired as the first value, and the density value Afi of the i-th raster RT0 of the second pattern DP2 is acquired as the second value.

After acquisition of the density values Aei, Afi, the control section 110 calculates the average value Ai of the density values Aei and Afi, that is, Ai=(Aei+Afi)/2, of the target location (S204).

After calculating the average value Ai, the control section 110 determines the printing density adjustment value G3i for the i-th nozzle 222 based on the average value Ai (S206). FIG. 11 illustrates a correspondence CO1 between the single-color densities G1i and G2i. The single-color density means, for example, the densities of any single color of C, M, Y, and K. In FIG. 11, the horizontal axis represents the density G1i of the inputs (Input), and the vertical axis represents the density G2i of the outputs (Output). The adjustment value G3i means a value for correcting the output from the density G2i to the density Gli corresponding to the density G1i and can also be said to be an input value at which the output value becomes the density G1i. The control section 110 can obtain the adjustment value G3i, which results in the output value being the density G1i, according to the correspondence CO1 for each color.

After determining the adjustment value G3i, the control section 110 determines whether or not the adjustment value G3i has been determined for all of the nozzles 222 in the nozzle array 221 (S208). If a nozzle 222 for which the adjustment value G3i has not been determined remains, the control section 110 repeats the processes from S202 to S208. When the adjustment value G3i has been determined for all of the nozzles 222, the control section 110 sets the adjustment value G3i in the controller 210 of the printing device 2 (S210). Of course, the density pattern DP0 included in the captured image IM0 is not limited to the example shown in FIG. 3 and may be the density pattern DP0 as shown in FIGS. 4A to 4C. In any case, the adjustment value G31 of the printing density can be determined based on the average value Ai of the density value Aei obtained from the first pattern section PP1 included in the captured image IM0 and the density value Afi obtained from the second pattern section PP2 included in the captured image IM0.

Thereafter, when the control section 110 causes the printing device 2 to print an image, the printing device 2 forms an image on the medium ME0 with a density according to the adjustment value G3i (S212). In this way, the control section 110 can cause the printing device 2 to form a print image having a density according to the adjustment value G3i. Of course, the process of S212 does not need to be performed immediately after the S210 process.

The adjustment process may be performed by the controller 210 of the printing device 2. In this case, the controller 210 may set the adjustment value G3i by itself by performing the adjustment value determination process from S202 to S210. In the subsequent S212, the controller 210 applies the adjustment value G3i to the image to be printed, so that the print image PI0 with fewer printing density errors due to peripheral dimming can be formed on the medium ME0.

As described above, even when peripheral dimming occurs in the captured image IM0, the influence of peripheral dimming on the adjustment value G3i of the printing density can be reduced based on the captured image IM0 of the symmetrically arranged density pattern DP0. Therefore, in this specific example, it is possible to reduce an error in the adjustment value of the printing density due to peripheral dimming occurring in the captured image. The user US1 can easily adjust the printing density of the printing device 2 by imaging an image of the test pattern TP0 with the information terminal 1 such as a camera-equipped portable terminal.

### (4) Modifications

Various modifications can be made to the present disclosure.

For example, the order of the processes described above can be changed as appropriate. For example, in the imaging control process of FIG. 8, even if the guidance output process at S108 is not performed, an effect of making it possible to image an appropriate test pattern can be obtained.

The information terminal 1 may receive an operation of setting the size of the central region CA1 of the angle of view FA illustrated in FIG. 9 in the operation section 115. As a result, it is possible to reduce errors in the adjustment value of the printing density due to peripheral dimming in accordance with the environment of the user US1 or the like.

The arrangement region ARI of the density pattern DP0 within the imaging target region AR0 may not be point-symmetric with respect to the center CT1 but rather line-symmetric with respect to the symmetry axis AX0 as the reference. For example, as shown in FIG. 3, it is assumed that the first pattern DP1 and the second pattern DP2 are divided into upper and lower parts with respect to the symmetry axis AX1, which is along the horizontal side S3 and S4, as the reference. When the first pattern DP1 and the second pattern DP2 both have the same trapezoidal shape with the left side being longer than the right side, the arrangement region AR1 of the density pattern DP0 is not point-symmetrical but line-symmetrical with respect to the symmetry axis AX1 as the reference. As shown in FIG. 4B, in the density pattern DP0, a portion above the symmetry axis AX1 corresponds to the first pattern section PP1, and a portion below the symmetry axis AX1 corresponds to the second pattern section PP2. When the density pattern DP0 has a trapezoidal shape and the left side of the trapezoid is longer than the right side, the arrangement region AR1 of the density pattern DP0 is not point-symmetrical but line-symmetrical with respect to the symmetry axis AX1 as the reference.

Further, the arrangement region AR1 of the density pattern DP0 with respect to the imaging target region AR0 may not be line symmetric with respect to the symmetry axis AX0 as the reference as long as it may be point symmetric with respect to the center CT1 as a reference. For example, as shown in FIG. 3, it is assumed that the first pattern DP1 and the second pattern DP2 are divided into upper and lower parts with respect to the symmetry axis AX1, which is along the horizontal side S3 and S4, as the reference. When both the first pattern DP1 and the second pattern DP2 are the same parallelogram shape that is not a rectangle, the arrangement region AR1 of the density pattern DP0 is not line-symmetric but is point-symmetric with respect to the center CT1 as the reference. As shown in FIG. 4B, in the density pattern DP0, a portion above the symmetry axis AX1 corresponds to the first pattern section PP1, and a portion below the symmetry axis AX1 corresponds to the second pattern section PP2. In a case where the density pattern DP0 is a parallelogram which is not a rectangle, the arrangement region AR1 of the density pattern DP0 is not line symmetric but point symmetric with respect to the center CT1 as the reference.

### (5) Conclusions

As described above, according to the present disclosure, it is possible to provide a configuration and the like capable of reducing the error of the adjustment value of the printing density due to peripheral dimming occurring in the captured image by various aspects. As a matter of course, the above-described basic operations and effects can be obtained even in an aspect including only the constituent features according to the independent claims.

A configuration in which the respective configurations disclosed in the above-mentioned examples are replaced with each other or combinations thereof are changed, a configuration in which the respective configurations disclosed in the publicly known art and the above-mentioned examples are replaced with each other or combinations thereof are changed, and the like can be implemented. The present disclosure includes these configurations and the like.

What is claimed is:

1. A test pattern used for imaging in an imaging section of an information terminal to adjust printing characteristics of a printing device that includes a recording head, wherein
a density pattern for adjusting printing density, as one of the printing characteristics, is included in an imaging target region of the test pattern and
an arrangement region of the density pattern within the imaging target region is symmetrical with respect to either a center of the imaging target region or a straight line passing through the center as a reference.

2. The test pattern according to claim 1, wherein
the imaging target region is rectangular,
the test pattern includes a finder pattern in each of the four corners of the imaging target region, the straight line is a symmetry axis along one side of the rectangular area, and
the arrangement region of the density pattern within the imaging target region is line-symmetric with respect to the symmetry axis as the reference.

3. The test pattern according to claim 1, wherein
a plurality of density patterns is provided,
the plurality of density patterns includes a first pattern and a second pattern, both having the same shape, and
an arrangement region of the first pattern and an arrangement region of the second pattern are symmetrical with respect to either the center or the straight line as the reference.

4. The test pattern according to claim 1, wherein
the density pattern is located at a position that includes a center of the imaging target region and
the arrangement region of the density pattern is symmetrical with respect to either the center or the straight line as the reference.

5. The test pattern according to claim 1, wherein
the imaging target region is rectangular with long sides and short sides,
the straight line is a symmetry axis along the short side, and
the arrangement region of the density pattern within the imaging target region is line-symmetric with respect to the symmetry axis as the reference.

6. The test pattern according to claim 5, including
an imaging direction indicating pattern that shows a direction of imaging so that the imaging section captures an image with the long side oriented vertically.

7. An imaging control program that causes an imaging section to capture a test pattern for adjusting printing characteristics of a printing device including a recording head, wherein
a density pattern for adjusting printing density as a printing characteristic is included in an imaging target region of the test pattern,
an arrangement region of the density pattern within the imaging target region is symmetrical with respect to either a center of the imaging target region or a straight line passing through the center as a reference, and
the imaging control program enables a computer to execute:
a determination function to judge whether an imaging condition is satisfied, the imaging condition including at least a condition of the center of the imaging target region being within a predetermined central region in an angle of view of the imaging section and
an imaging control function configured to acquire a captured image by causing the imaging section to image the imaging target region with satisfaction of the imaging condition as a trigger.

8. A printing system comprising:
a printing device including a recording head and
an information terminal configured to capture an image of a test pattern for adjusting printing characteristics of the printing device, wherein
a density pattern for adjusting printing density as a printing characteristic is included in an imaging target region of the test pattern,
an arrangement region of the density pattern within the imaging target region is symmetrical with respect to either a center of the imaging target region or a straight line passing through the center as a reference, and
the information terminal includes
an imaging section and
a control section that includes a memory for storing a captured image obtained from the imaging section and that causes the imaging section to image the imaging target region, and
the control section judges whether an imaging condition is satisfied, the imaging condition including at least a condition that a center of the imaging target region is within a predetermined central region in an angle of view of the imaging section, the control section acquiring the captured image by causing the imaging section to execute imaging of the imaging target region with satisfaction of the imaging condition as a trigger.

9. The printing system according to claim 8, wherein
the density pattern includes a first pattern section and a second pattern section whose arrangement regions are symmetrical with respect to either the center or the straight line as the reference and
the printing system determines an adjustment value for the printing density based on an average of a first value obtained from the first pattern section in the captured image and a second value obtained from the second pattern section in the captured image.
